(19) United States
(12) Patent Application Publication
(10) Pub. No.: US 2022/0295740 A1
(43) Pub. Date: Sep. 22, 2022

(54) HAY BALE HORSE FEEDING DEVICE

(71) Applicants: Glen Lorne Williams, Innisfil (CA); Melissa Potts Williams, Innisfil (CA)

(72) Inventors: Glen Lorne Williams, Innisfil (CA); Melissa Potts Williams, Innisfil (CA)

(21) Appl. No.: 17/204,368

(22) Filed: Mar. 17, 2021

(51) Int. Cl. A01K 1/10

(52) U.S. Cl. CPC A01K 1/10

(57) ABSTRACT

A hay bale feeding device that is configured to be surroundably mounted a hay bale and provide access thereto for feeding by animals in order to assist in controlling the rate of consumption of the hay by the animals. The present invention includes a support ring member wherein the support ring member is configured to encircle a hay bale proximate the bottom thereof. A body is secured to the support ring member wherein the body is nylon netting having a plurality of apertures. The support ring member further includes a coupler wherein the coupler has a first portion and second portion that are releasably secured. The coupler provides access to the hollow passage of the support ring member so as to facilitate the ability for a material to be deposited therein so as to increase the weight of the support ring member.

### FIELD OF THE INVENTION

The present invention relates generally to livestock caretaking, more specifically but not by way of limitation, a horse feeding device wherein the device of the present invention is configured to surroundably mount a hay bale so as to control the ingestion rate of the hay by horses and further provide additional structural benefits.

### BACKGROUND

As is known in the art, caretaking of livestock and other large animals such as horses requires a significant amount of effort. Routine tasks of cleaning and feeding require a great deal of time and is important to the overall health of the animal. By way of example but not limitation, horses require constant care that ranges from grooming, stall cleaning and feeding. For the later it is important to control not only the type of feed that is provided to the horses but also the rate of consumption thereof. Horses and other animals if provided the opportunity will feed at a rate too quick and as such digestion and other complications can occur. In order to control the rate of consumption various tactics and/or devices have been employed to control the rate of consumption as well as reduce the amount of waste of the feed.

One food source for horses is the conventional hay bale. The hay bale is placed in an area that is accessible by the horses. The horses will grasp hay from the bale and eat. If not controlled, horses will remove hay from the bale not only too fast but also in a manner such that wasted hay is produced and ultimately not consumed by the horse. Conventional netting has been used to attempt to control the rate of consumption and while this has worked somewhat, these nets have significant deficiencies. The conventional netting placed over hay bales typically requires two people to place over the hay bale and additionally requires tying to the hay bale. Furthermore, the conventional nets placed on hay bales often have a portion thereof that will be underneath the hay bale and in contact with the ground wherein this portion is often frozen and trapped when exposed to severe winter climates.

It is intended within the scope of the present invention to provide a hay bale feeding device that is operable to surroundably mount a hay bale wherein the present invention provides a controlled rate of feeding and further provides a support ring member at the lower perimeter edge of the hay bale.

### SUMMARY OF THE INVENTION

It is the object of the present invention to provide a hay bale encapsulating device that is configured to assist to controlling the feeding rate of horses wherein the present invention is configured to be surroundably secured a bale of hay.

Another object of the present invention is to provide a hay bale feeding device that is operable to surroundably mount a bale of hay and maintain the position thereof wherein the present invention includes a support ring member.

A further object of the present invention is to provide a hay bale encapsulating device that is configured to assist to controlling the feeding rate of horses wherein the support ring member is substantially hollow.

Still another object of the present invention is to provide a hay bale feeding device that is operable to surroundably mount a bale of hay and maintain the position thereof wherein the support ring member includes a union wherein the union is configured to provide access to the hollow passage of the support ring member.

An additional object of the present invention is to provide a hay bale encapsulating device that is configured to assist to controlling the feeding rate of horses that further includes a body wherein the body is manufactured of netting material and is secured to the support ring member being expandable outward therefrom to envelop a bale of hay.

Yet a further object of the present invention is to provide a hay bale feeding device that is operable to surroundably mount a bale of hay and maintain the position thereof wherein the support ring member can be filled with a material to inhibit the movement thereof.

Another object of the present invention is to provide a hay bale encapsulating device that is configured to assist to controlling the feeding rate of horses wherein the body of netting material includes a plurality of apertures that are provided in at least two sizes.

An alternate object of the present invention is to provide a hay bale feeding device that is operable to surroundably mount a bale of hay and maintain the position thereof wherein the body is manufactured from a material such as but not limited to nylon.

Still a further object of the present invention is to provide a hay bale encapsulating device that is configured to assist to controlling the feeding rate of horses wherein the present invention is provided in alternate sizes in order to accommodate different sizes of hay bales.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is an end view of a union of the support ring member of the present invention; and

FIG. 2 is a detailed view of the union of the support ring member; and

FIG. 3 is a perspective view of the present invention; and

FIG. 4 is a partial view of the body of the present invention.

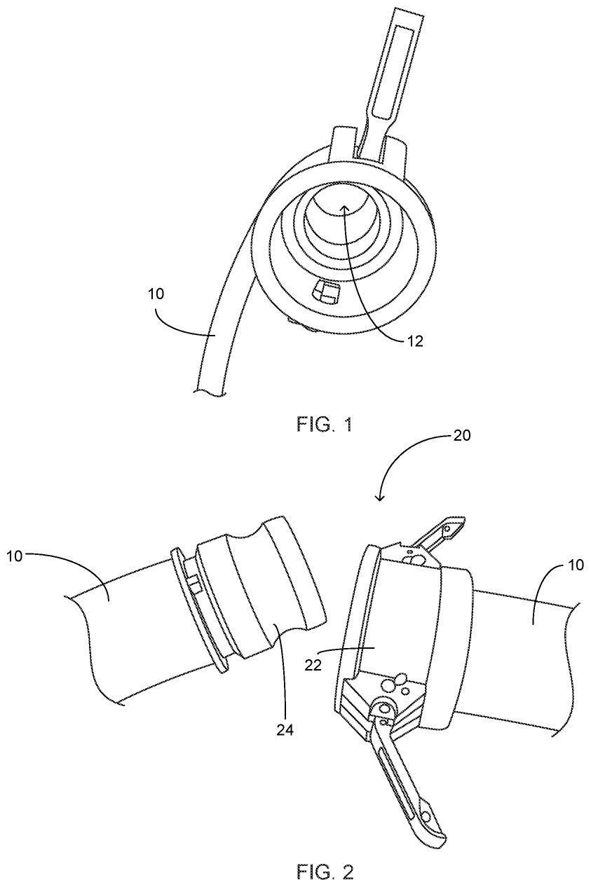

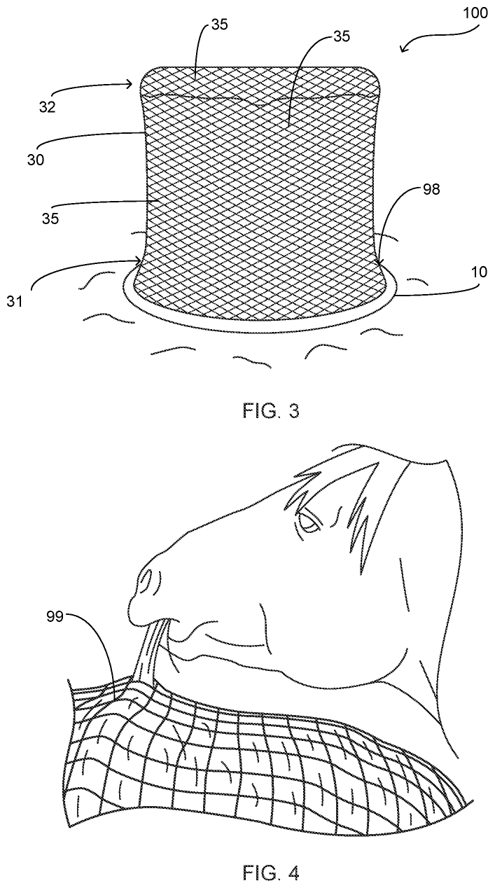

### DETAILED DESCRIPTION

Referring now to the drawings submitted herewith, wherein various elements depicted therein are not necessarily drawn to scale and wherein through the views and figures like elements are referenced with identical reference numerals, there is illustrated a hay bale feeding device 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring to the Figures submitted as a part hereof, the hay bale feeding device 100 further includes a support ring member 10. The support ring member 10 is manufactured from plastic or other suitable durable material and includes a hollow passage 12 extending therethrough. The support ring member 10 is configured to encircle the hay bale 99 proximate the bottom edge 98 thereof. The support ring member 10 is configured to be superposed the ground and inhibit access to the hay bale 99 from underneath the support ring member 10. The support ring member 10 is configured with the hollow passage 12 so as to be able to be filled with a material such as but not limited to sand. The hollow passage 12 of the support ring member 10 provides the ability to place sand therein so as to increase the weight of the support ring member 10. In some cases, it may be desirable to increase the weight of the support ring member 10 so as to ensure the maintenance of position of the hay bale feeding device 100 when exposed to either a plurality of or an aggressive animal. It should be understood within the scope of the present invention that the support ring member 10 could be formed in alternate diameters so as to encircle various sizes of hay bales. While the support ring member 10 is illustrated herein as being ring-shaped, it is contemplated within the scope of the present invention that the support ring member 10 could be mateably shaped with a hay bale 99 that is manufactured in an alternate shape.

The support ring member 10 includes a coupler 20. The coupler 20 functions to separate the support ring member 10 so as to provide access to the hollow passage 12. The coupler 20 includes a first portion 22 and a second portion 24 wherein the first portion 22 and second portion 24 are releasably secured to each other. This allows for the coupler 20 to be separated so a user can place a material in the hollow passage 12. While no particular type of coupler is required, good results have been achieved utilizing a cam-lock for the coupler 20. While one coupler 20 is illustrated herein, it is contemplated within the scope of the present invention that more than one coupler 20 could be provided on the support ring member 10 so as to create and provide access to segments thereof. While a coupler 20 is provided in the preferred embodiment of the present invention, it is contemplated within the scope of the present invention that the support ring member 10 could be provided as a single piece and have varying weights in order to achieve the desired stability and maintenance of position thereof as discussed herein.

The hay bale feeding device 100 further includes a body 30. The body 30 is configured to surroundably mount a hay bale 99. The body 30 includes a lower end 31 and an upper end 32 wherein the lower end 31 is secured to the support ring member 10. The body 30 is manufactured from a nylon netting material that includes a plurality of apertures 35. The apertures 35 provide access to the hay bale 99 for horses and other animals but control the ability at which the hay can be separated from the hay bale 99 for consumption. While no particular size of the apertures 35 is required, good results have been achieved with apertures 35 being either one and one-quarter inch or one and three-quarter inch in size.

The body 30 is secured to the support ring member 10 through suitable techniques and is configured so as not to egress underneath the hay bale 99. This prevents the body 30 from becoming entrapped or frozen in the ground on which the hay bale feeding device 100 is superposed. The body 30 is operably coupled to the support ring member 10 so as to surroundably mount the hay bale 99 wherein the hay bale feeding device 100 is placed over the hay bale 99 and surrounds the entire bale from the top to the ground. It should be understood within the scope of the present invention that the body 30 could be manufactured in alternate sizes so as to accommodate various heights of hay bales 99. It should be further understood that while nylon netting is the preferred embodiment, the body 30 could be manufactured from alternate materials.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A hay bale feeding device that is configured to be surroundably mounted a hay bale and provide access thereto for feeding by animals wherein the hay bale feeding device comprises:
a support member, said support member being mateably shaped to circumferentially surround a base of a hay bale, said support member being a contiguous piece of material, said support member having sufficient weight to maintain its position circumferentially on the hay bale;
a body, said body being secured to said support member, said body having a lower end and an upper end, said body configured to extend upward from said support member, said body being of suitable size so as to surroundably mount the hay bale, said body having a plurality of apertures; and
wherein said plurality of apertures are of a suitable size to allow an animal to access a portion of the hay bale and extract hay therefrom for feeding.

2. The hay bale feeding device as recited in claim 1, wherein said body is manufactured from nylon netting.

3. The hay bale feeding device as recited in claim 2, wherein said support member is ring shaped.

4. The hay bale feeding device as recited in claim 3, wherein said plurality of apertures of said body are provided in one of the following sizes: one and one quarter inch or one and three quarter inch.

5. The hay bale feeding device as recited in claim 4, wherein said support member further includes a hollow passage therethrough.

6. The hay bale feeding device as recited in claim 5, wherein said support member further includes at least one coupler, said at least one coupler configured to separate said support member so as to provide access to said hollow passage.

7. The hay bale feeding device as recited in claim 6, wherein said at least one coupler is operable to provide access to said hollow passage of said body so as to place a material therein in order to increase a weight of said support member.

8. A hay bale feeding device that is configured to be surroundably mounted a hay bale and provide access thereto for feeding by animals wherein the hay bale feeding device comprises:
a support ring member, said support ring member being ring shaped, said support ring member having a hollow passage therethrough, said support ring member having a diameter sufficient in size so as to encircle the hay bale proximate a bottom thereof;
a coupler, said coupler being operably secured to said support ring member, said coupler having a first portion and a second portion, said first portion and said second portion of said coupler being releasably secured, said coupler configured to provide access to said hollow passage so as to allow a material to be deposited therein; and
a body, said body being secured to said support ring member, said body having a lower end and an upper end, said body configured to extend upward from said support ring member, said body being of suitable size so as to surroundably mount the hay bale, said body having a plurality of apertures; and
wherein said plurality of apertures are of a suitable size to allow an animal to access a portion of the hay bale and extract hay therefrom for feeding.

9. The hay bale feeding device as recited in claim 8, wherein said body is manufactured from nylon netting.

10. The hay bale feeding device as recited in claim 9, wherein said plurality of apertures of said body are provided in one of the following sizes: one and one quarter inch or one and three quarter inch.
